(19) United States
(12) Patent Application Publication
(10) Pub. No.: US 2017/0270572 A1
(43) Pub. Date: Sep. 21, 2017

(54) SYSTEM AND METHOD FOR AUTONOMOUS INTERNET SEARCHING AND DISPLAY OF PRODUCT DATA AND SENDING ALERTS

(71) Applicant: Trackstreet, Inc., Las Vegas, NV (US)

(72) Inventor: Andrew Schydlowsky, Las Vegas, NV (US)

(73) Assignee: Trackstreet, Inc., Las Vegas, NV (US)

(21) Appl. No.: 15/462,460

(22) Filed: Mar. 17, 2017

Related U.S. Application Data
(60) Provisional application No. 62/310,312, filed on Mar. 18, 2016.

(51) Int. Cl. G06Q 30/02; G06F 17/30

(52) U.S. Cl. CPC G06Q 30/0282; G06F 17/30887; G06F 17/30867

(57) ABSTRACT

A system and method to analyze product information by receiving product information from a third party server. The system filters the product information for review information, generates a score for the review information, and generates a notification based on the score.

### CROSS REFERENCE TO RELATED APPLICATIONS

This application claims the benefit of U.S. Provisional Application No. 62/310,312, filed Mar.18, 2016, which is incorporated herein by reference in its entirety to provide continuity of disclosure.

### FIELD OF THE INVENTION

The present invention relates to systems and methods to analyze product information.

### BACKGROUND OF THE INVENTION

Retail websites store and display product review information. The reviews are posted by users of the website and help prospective purchasers make informed buying decisions. A problem with this review information is that it is from a limited source and leaves out review information from other websites, such as other retail websites or social media websites. Additionally, retail websites offer limited functionality for generating, analyzing, and reviewing trend data related to the review information.

### BRIEF DESCRIPTION OF THE DRAWINGS

The disclosed embodiments will be described with reference to the accompanying drawings.

FIG. 1 is a system diagram of a preferred embodiment.

FIG. 2 is an application diagram of a preferred embodiment.

FIGS. 3A through 3I are flow charts of methods of a preferred embodiment.

FIGS. 4A through 4D are data flow diagrams of a preferred embodiment.

FIG. 5 illustrates a user interface for displaying reviews by location of a preferred embodiment.

FIG. 6 illustrates a user interface for browsing reviews in accordance with a preferred embodiment.

FIG. 7 illustrates a user interface for displaying trend information in accordance with a preferred embodiment.

FIG. 8 illustrates a user interface for updating settings in accordance with a preferred embodiment.

FIG. 9 illustrates a user interface for displaying reviews by product in accordance with a preferred embodiment.

### DETAILED DESCRIPTION

A method and apparatus is disclosed for collecting, analyzing, and displaying product information and product reviews with a continuously operating internet robot or crawler. Data analysis, reports and email notifications of various events are automatically generated.

It will be appreciated by those skilled in the art that aspects of the present disclosure may be illustrated and described herein in any of a number of patentable classes or context including any new and useful process, machine, manufacture, or composition of matter, or any new and useful improvement thereof. Therefore, aspects of the present disclosure may be implemented entirely in hardware, entirely in software (including firmware, resident software, micro-code, etc.) or combining software and hardware implementation that may all generally be referred to herein as a “circuit,” “module,” “component,” or “system.” Further, aspects of the present disclosure may take the form of a computer program embodied in one or more computer readable media having computer readable program code embodied thereon.

Any combination of one or more computer readable media may be utilized. The computer readable media may be a computer readable signal medium or a computer readable storage medium. For example, a computer readable storage medium may be, but not limited to, an electronic, magnetic, optical, electromagnetic, or semiconductor system, apparatus, or device, or any suitable combination of the foregoing. More specific examples of the computer readable storage medium would include, but are not limited to: a hard disk, a random access memory (“RAM”), a read-only memory (“ROM”), an erasable programmable read-only memory (“EPROM” or Flash memory), an appropriate optical fiber with a repeater, a portable compact disc read-only memory (“CD-ROM”), an optical storage device, a magnetic storage device, or any suitable combination of the foregoing. Thus, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. The propagated data signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, or any suitable combination thereof.

Computer program code for carrying out operations for aspects of the present disclosure may be written in any combination of one or more programming languages, including an object oriented programming language such as PHP, Java, C++, C#, .NET, Objective C, Ruby, Python SQL, or other modern and commercially available programming languages.

Aspects of the present disclosure are described with reference to flowchart illustrations and/or block diagrams of methods, systems and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices including phones and tablet devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

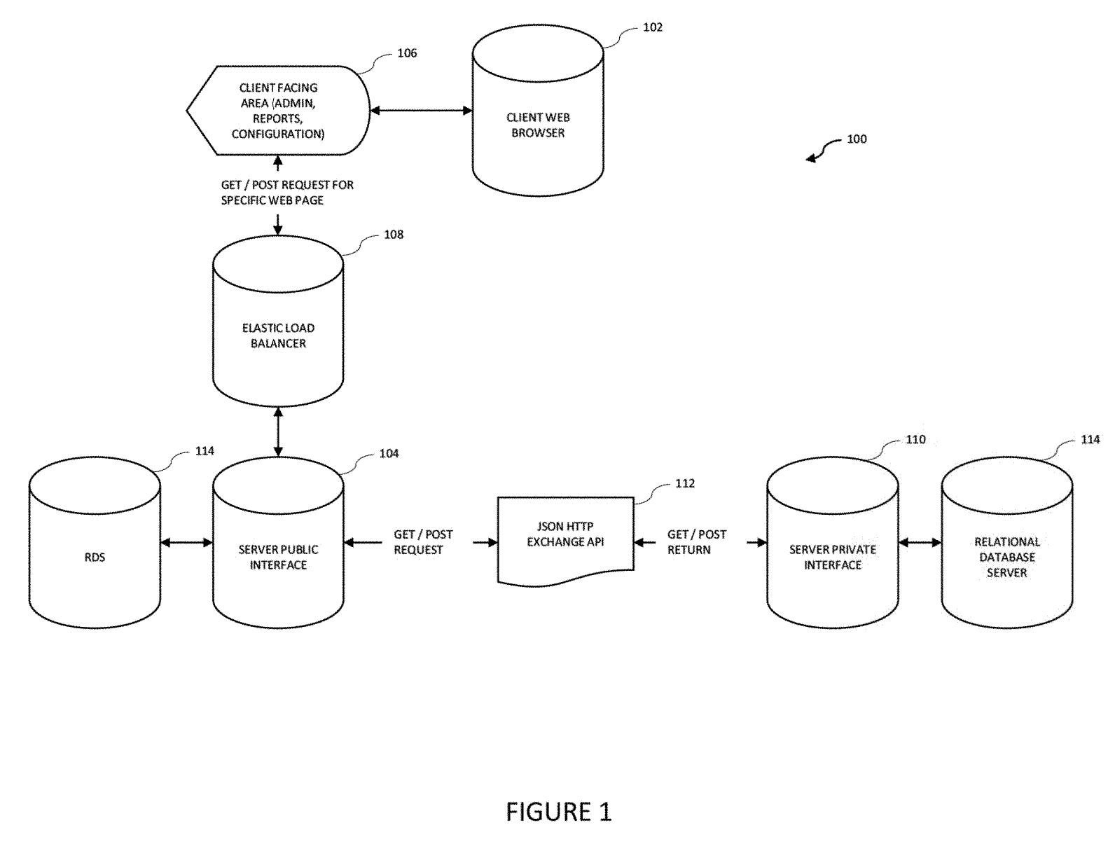

Referring to FIG. 1, system 100 includes a client connected to a server through the Internet with the server connected to a database. In a preferred embodiment, the client is web browser 102, which connects to public interface 104 of the server. The server comprises one or more physical servers or virtual servers, where the virtual servers operate on one or more of the physical servers. Each physical server comprises one or more memories, processors, and virtual processors. The web pages provided by the server are displayed by the client with client facing area 106. The server is hosted by a cloud computing platform, such as Amazon Web Services (AWS) from Amazon Web Services Inc. The network traffic from the one or more clients accessing the server are balanced with elastic load balancer 108. Public interface 104 of the server communicates with private interface 110 of the server using a JavaScript object notation (JSON) hypertext transfer protocol (HTTP) exchange application program interface (API) 112. Public interface 104 and private interface 110 both access the database of the system through relational database service 114.

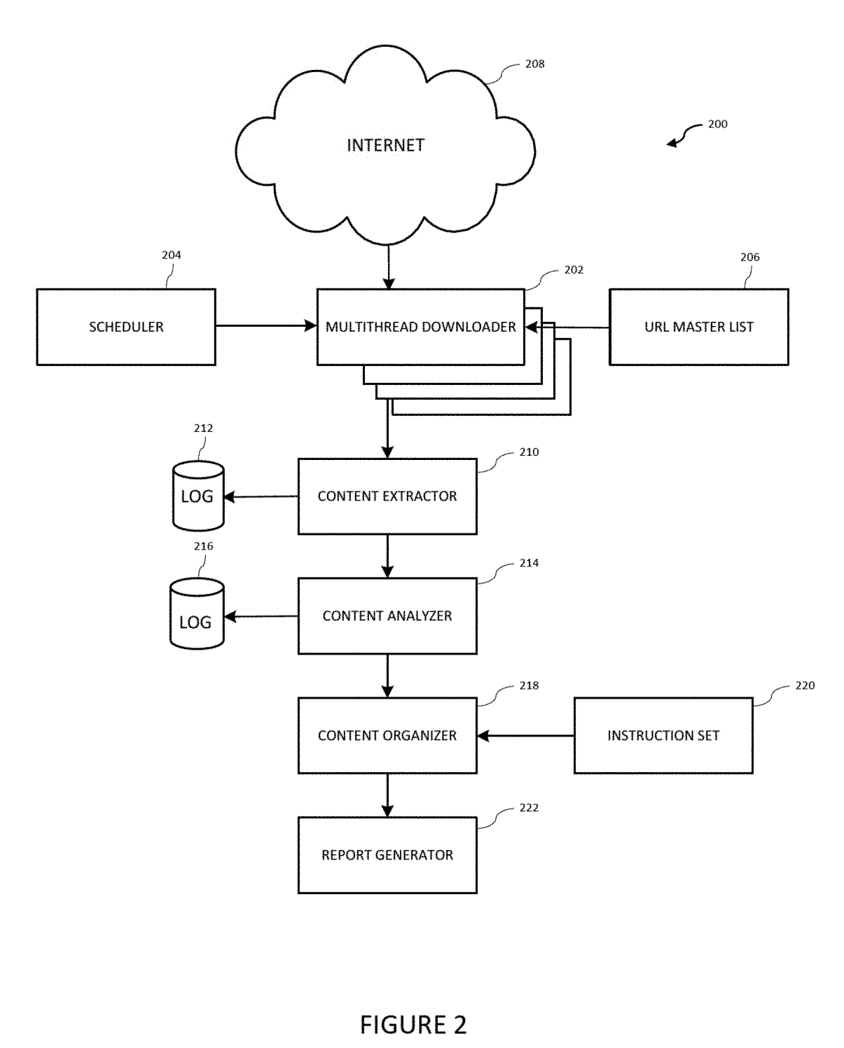

Referring to FIG. 2, system 200 comprises as multithread downloader 202 which is driven by scheduler 204 and uniform resource locator (URL) master list 206. Multithread downloader 202 operates continuously to locate and download content from Internet 208 based on URL master list 206. The content is delivered to content extractor 210 which parses hypertext markup language (HTML) code for various specifically defined information. When located, content extractor 210 delivers the information to content log 212.

System 200 includes content analyzer 214 connected to content extractor 210. Content analyzer 214 compares the chosen content to previous versions to determine if the content has changed from a prior crawl session and if so in what way. Content analyzer 214 then logs the differences to difference log 216.

System 200 includes content organizer 218 connected to content analyzer 214. Content organizer 218 is driven by instruction set 220 which determines the format of data presentation.

Content organizer 218 is connected to report generator 222, which derives an HTML code set for the display of organized content in a browser.

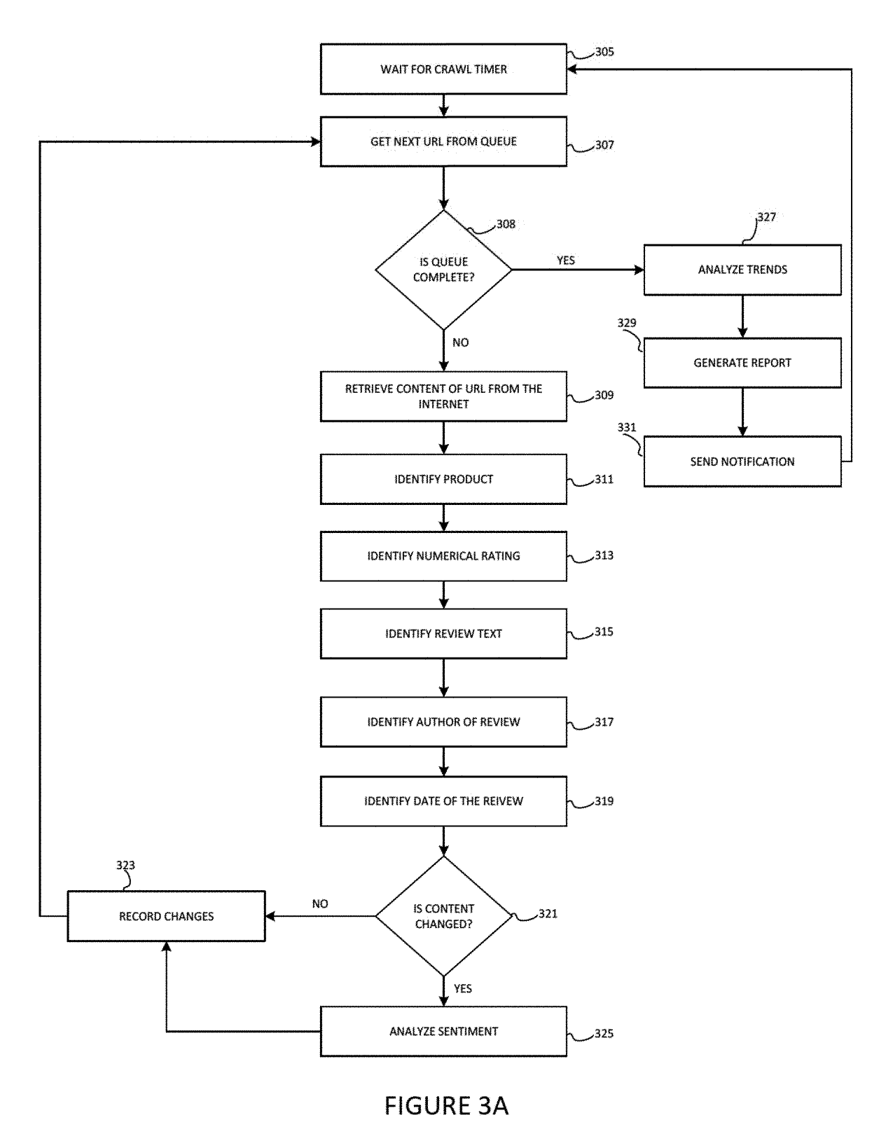

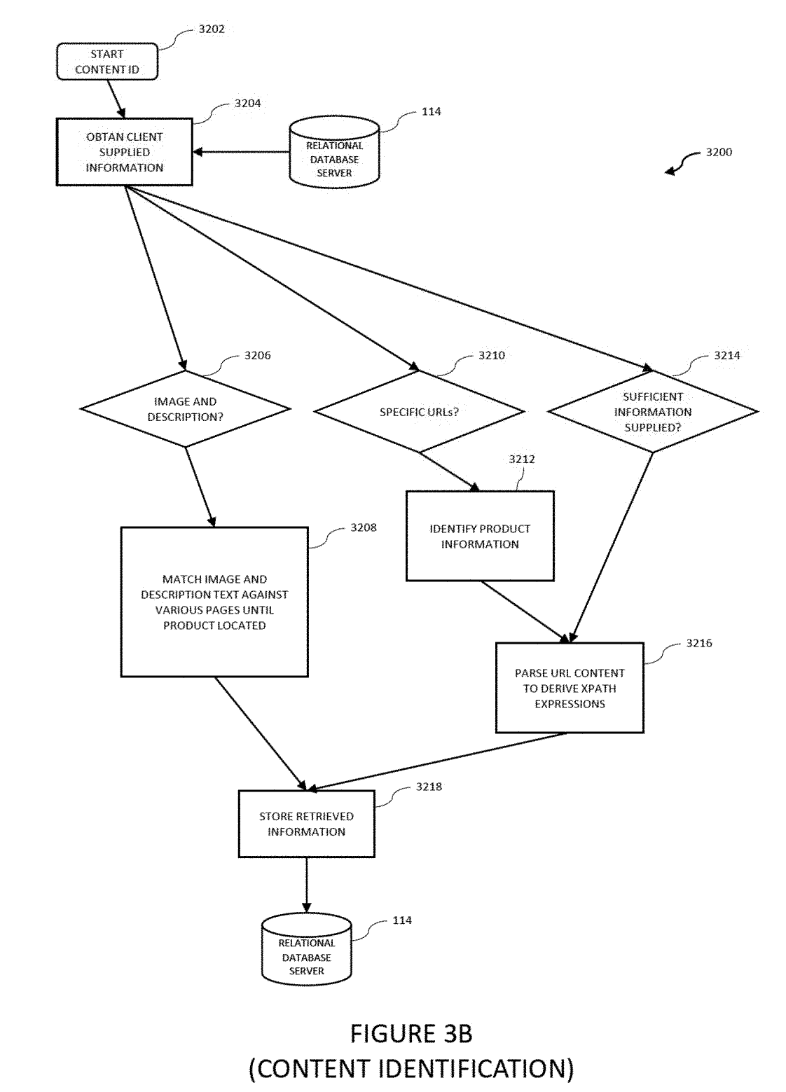

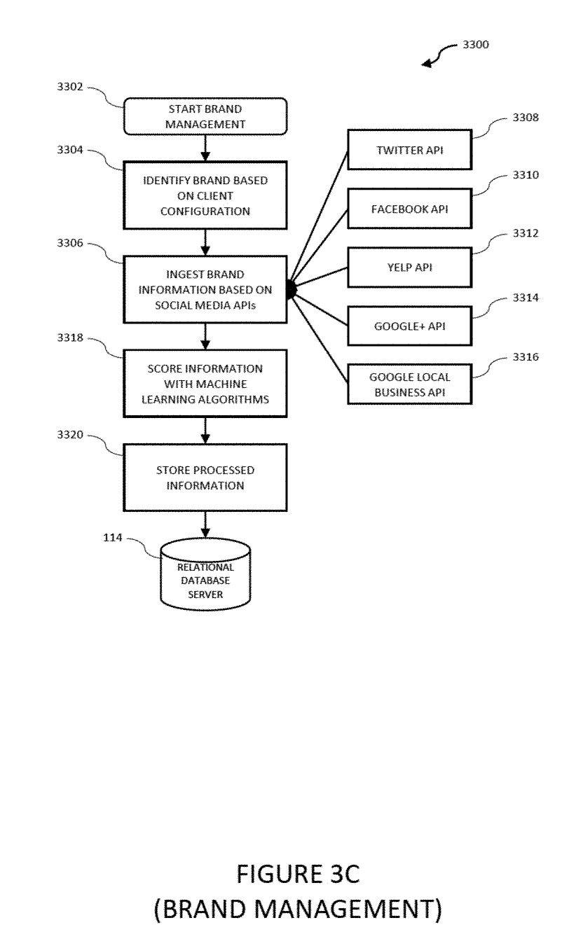

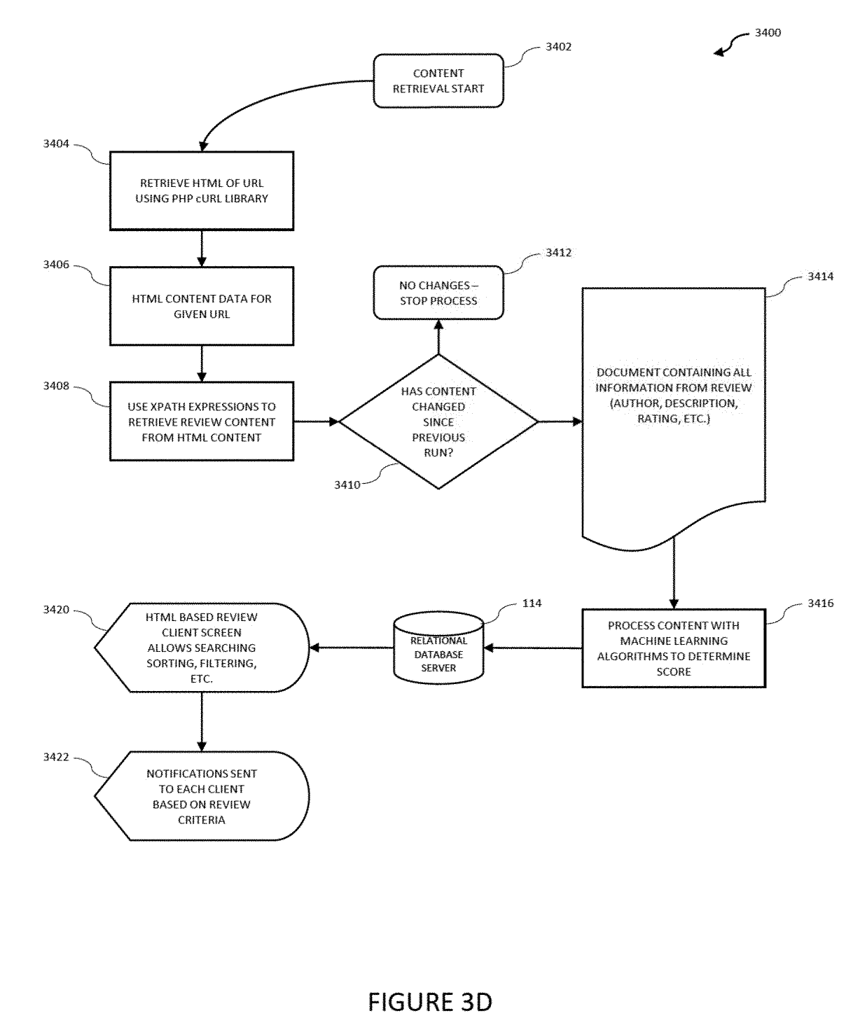

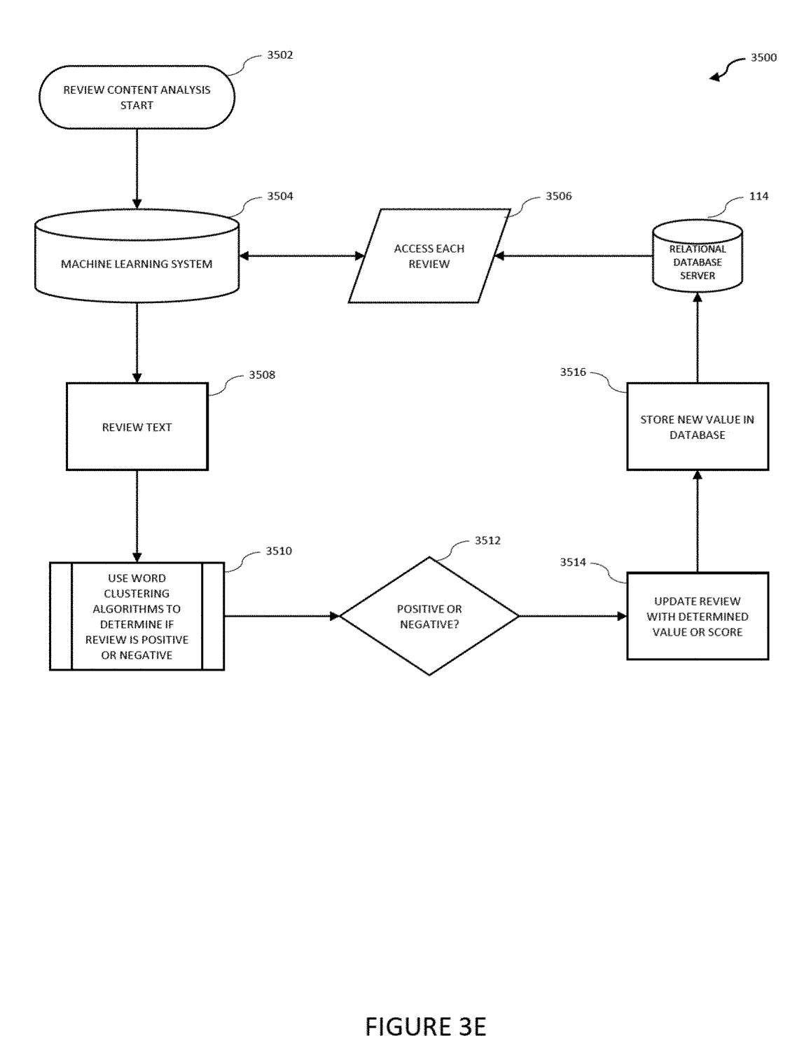

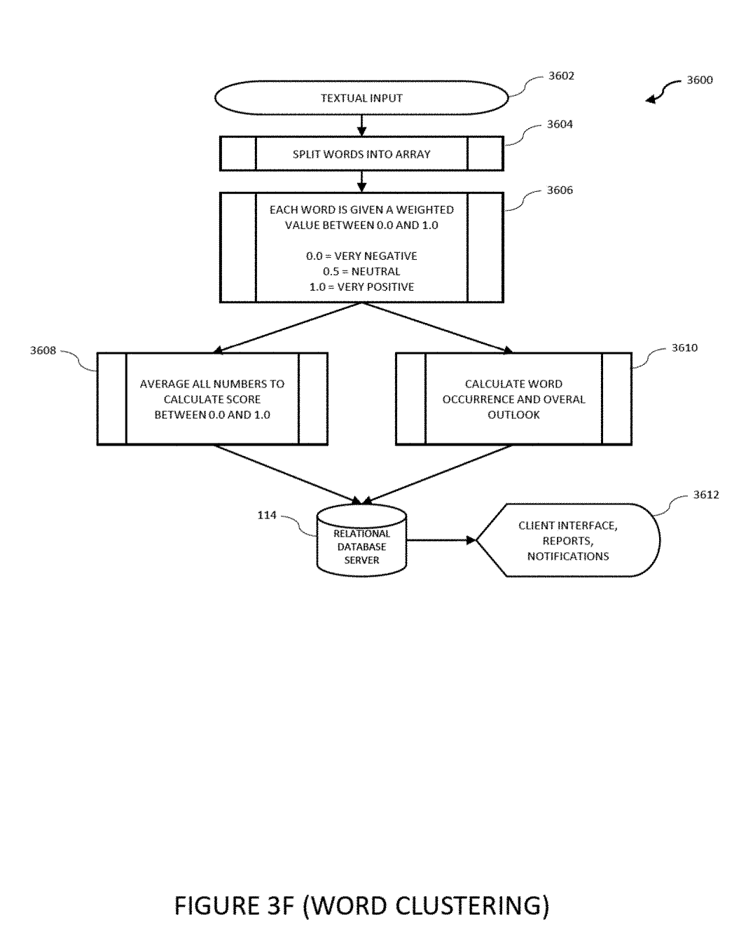

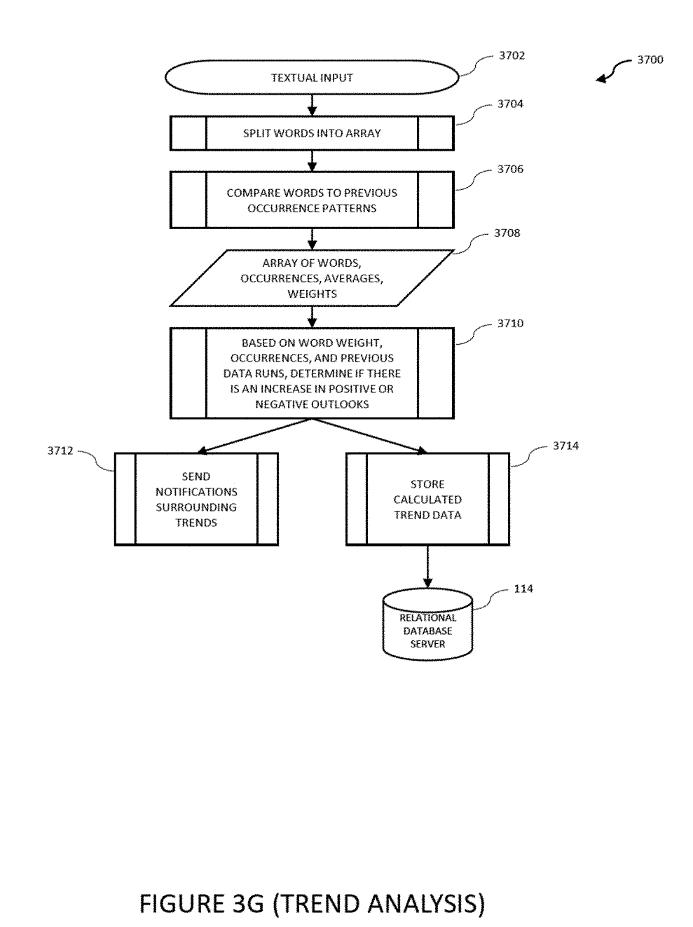

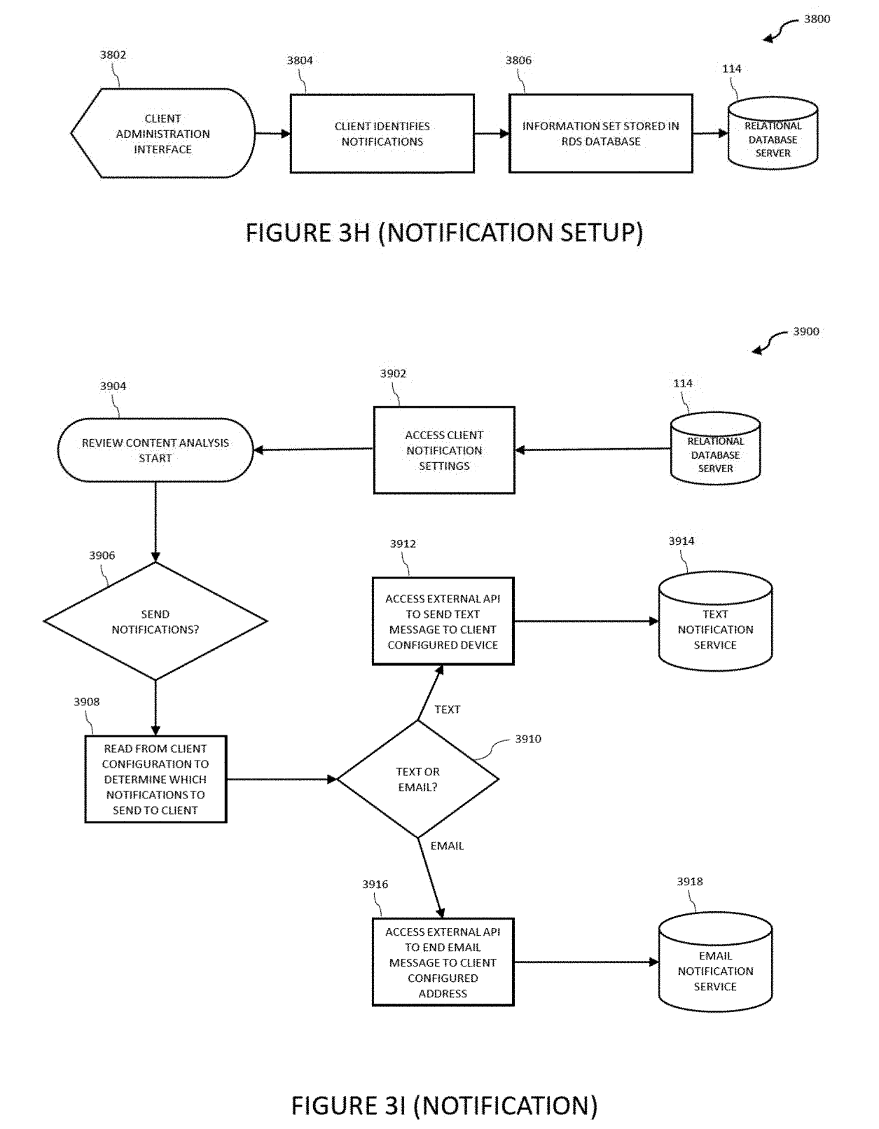

Referring to FIG. 3A, a flowchart of system operation is described.

At step 305, the system waits for a crawl timer interrupt. Upon occurrence of a crawl timer interrupt, the system moves to step 307. At step 307, the system retrieves a URL from queue to database. The URL queue is a stack of chosen URLs to be crawled. The system then moves to step 308. At step 308, the system checks to see if all the URL's in the queue have been crawled. If not, the system then moves to step 309. At step 309, the system retrieves the content of the URL from the internet. At step 311, the system identifies product and/or a product review in the retrieved content. At step 313, the system identifies a numerical rating for the product review. At step 315, the system identifies written review text in the content. At step 317, the system identifies author information in the content. At step 319, the system identifies the date of the review in the content.

At step 321, the system compares the review text to a prior logged review text for the same URL to determine if it has changed. If it has not changed, then the system moves to step 323 and records the changes. The system then returns to step 307. If it has changed, then the system moves to step 325. At step 325, the system analyzes sentiment based on common word phrases to indicate “good” or “bad” reviews and determines numerical ratings. The system then moves to step 323.

If at step 308, the system determines that all the URLs in the queue have been crawled, then the system moves to step 327. At step 327, the system compares the numerical ratings to determine trends. At step 329, the system generates a report based on instructions that are stored in the database. At step 331, the system sends a notification of the sentiment and of the reviews to the user via an email. The system then returns to step 305, to wait for a crawl timer interrupt.

Referring to FIG. 3B, process 3200 performs a first part of the content identification process and is used to generate URL master list 206 of FIG. 2 and to generate the parsers or filters used by content extractor 210 of FIG. 2. Process 3200 is a computer implemented method that identifies the location of content to process during the crawl and how to process the information during the crawl. In a preferred embodiment, process 3200 generates or updates URL master list 206 to identify the location of the content and process 3200 generates extensible markup language (XML) path language (XPath) expressions that are used to extract review information from the content retrieved with URL master list 206.

At step 3202, process 3200 begins. At step 3204, the server obtains product identification information from a client device. The product identification information includes one or more images, text descriptions, universal product codes (UPCs), stock keeping unit (SKU) codes, and URLs. Based on the type of information received from the client, additional information may be retrieved from the database through relational database service 114. The additional information supplements the client provided information to increase the probability of finding correct content in the Internet.

At step 3206, the system determines if an image and description were provided by the client. If an image was received, then at step 3208, the system searches one or more websites on the Internet for the description, including retail websites, product review websites, and social media websites. Images included with the pages within the search results are compared with the images provided by the client. In a preferred embodiment, the system checks to see if the client image and a search result image are the same resolution and, if so, a Hamming distance is determined by subtracting the values for each pixel. The number of pixels that are different identify a “distance” between the two images and if this distance is less than a threshold percentage, e.g., 5%, then the images are determined to be matching images. If a match is found, the URL associated with the search result image is added to URL master list 206.

At step 3210, if a specific URL is provided by the client, then process 3200 proceeds to step 3212 where the specific URL is accessed by the system. After accessing the specific URL, the system identifies other product information from the content that was returned from accessing the specific URL. The other product information includes images, descriptions, and codes that identify the specific product, which were not supplied by the client. The process then proceeds to step 3216.

At step 3214, if all required information is provided by the client, then no additional product information is identified and the process proceeds to step 3216.

At step 3216, the URL associated an identified product is accessed and the content from the URL is processed. Optionally, other Internet websites are searched for matching product information to identify additional websites to add to URL master list 206. The content from the one or more URLs is analyzed to locate review information that includes ratings, authors, and review text. In a preferred embodiment, one or more XPath expressions are derived that identify the review information in the URLs associated with the product information.

At step 3218, the system stores new information that was generated or retrieved, including new URLs that were not already part of URL master list 206 and their associated XPath expressions for extracting review information. The new information is stored to the database using relational database service 114.

Referring to FIG. 3C, process 3300 allows for brand management. Process 3300 is performed by content extractor 210 and content analyzer 214 to extract and analyze information from social media websites. Process 3300 retrieves and processes review information from additional Internet websites, such as from social media websites that are structured differently that traditional retail websites. Process 3300 is part of the crawling process that retrieves and analyzes information from the Internet.

At step 3302, process 3300 begins. At step 3304, a brand is identified based on a client configuration. In a preferred embodiment, all of the product identification information supplied by the client and/or supplemented by the system is collected. Keywords are generated that are associated with the brand of the client.

At step 3306, the system ingests brand information based on social media APIs. In a preferred embodiment, the social media APIs include one or more of Twitter API 3308, Facebook API 3310, Yelp API 3312, Google+ API 3314, Google local business API 3316. The system generates API calls to the different website APIs and stores the information returned from the different websites.

At step 3318, the content received at step 3306 is scored with one or more machine learning algorithms to determine if each piece of information is positive or negative. For example, calls to Twitter API 3308 return several tweets related to the brand that is being processed. For each tweet the amount of positive words and the amount of negative words are weighted, counted, and averaged. Each word has a weight that identifies if it is positive or negative the word is and also how strongly positive or negative it is. In one embodiment, positive words are given positive values that range from above 0.5 to 1.0 and negative values are given values that range from 0.0 to below 0.5, with the value of 0.5 being neutral.

At step 3320, the scores generated by the system are stored for each of the items of information retrieved from the website APIs to the database using relational database service 114.

Referring to FIG. 3D, computer-implemented process 3400 retrieves, processes, and displays review information in accordance with a preferred embodiment. Process 3400 supplements and extends the method of FIG. 3A and includes steps performed by content extractor 210, content analyzer 214, content organizer 218, and report generator 222.

At step 3402, process 3400 begins.

At step 3404, a server of the system retrieves HTML content from one or more URLs from URL master list 206. In a preferred embodiment, the application running on the server that is used to retrieve the HTML content is written in PHP: Hypertext Preprocessor (PHP) using the CURL library.

At step 3406, the analysis for the HTML content data from a single URL request begins.

At step 3408, review content is extracted from the HTML content data. In a preferred embodiment, one or more XPath expressions identify pertinent portions of the HTML content data that are extracted, including one or more of an author name, review text, and a rating. This extracted data is referred to collectively as review information.

At step 3410, the system determines if the review information has changed since the last time the review information was accessed, i.e., during the previous crawl. If the information has not changed, then process 3400 stops at step 3412. Otherwise, process 3400 continues on to generate document 3414. Document 3414 includes all the information extracted from the HTML content data.

At step 3416, document 3414 is processed and scored using machine learning algorithms. The score is associated with the review information and identifies if the review text from the review information includes a positive review of the product or a negative of the product. In one embodiment, the machine learning algorithms include a neural network that is trained on pre-classified data and then used to generate the score. The review information of document 3414 and the score are saved to the database using relational database service 114.

The system generates an HTML review page that aggregates the review information pulled from several URLs and the scores generated for and included with the review information. The HTML review page is displayed by the client device at step 3420.

The system generates one or more notifications based on the review information and analysis of the review information. The notifications are sent to and displayed one or more clients at step 3422.

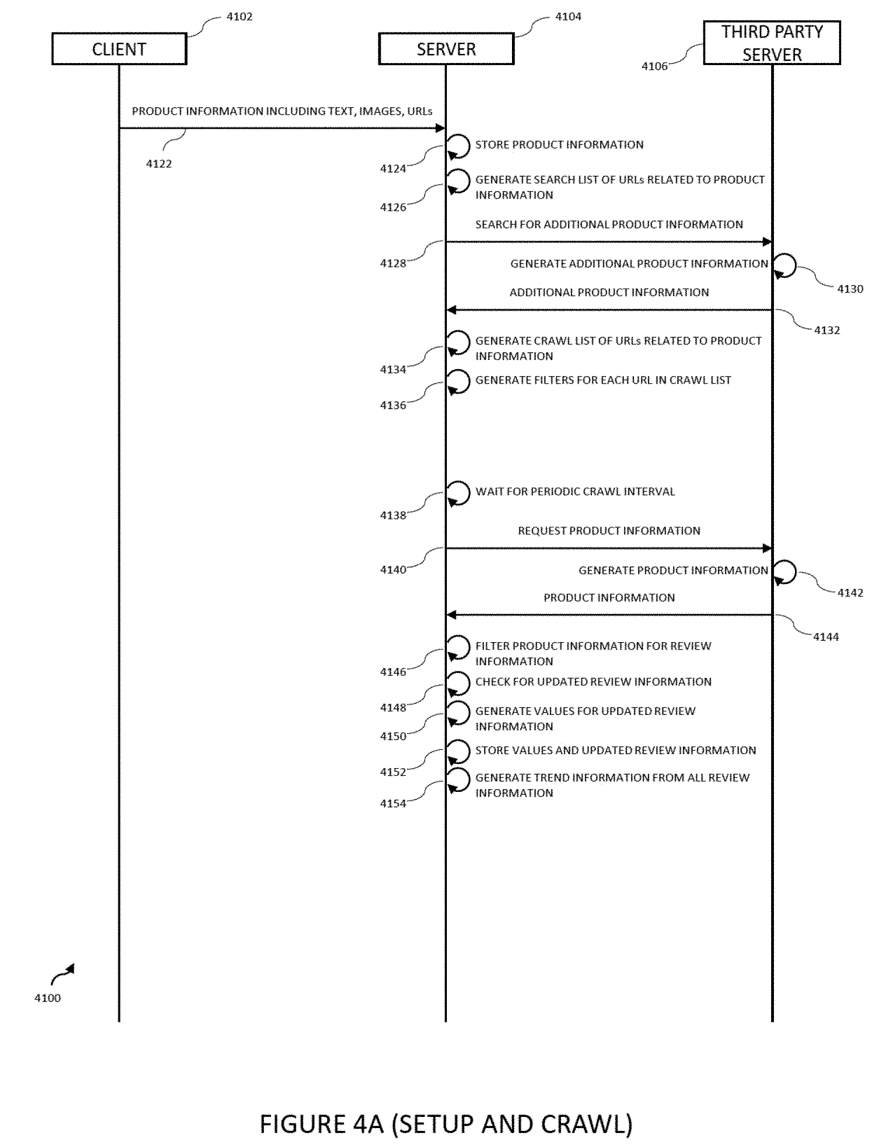

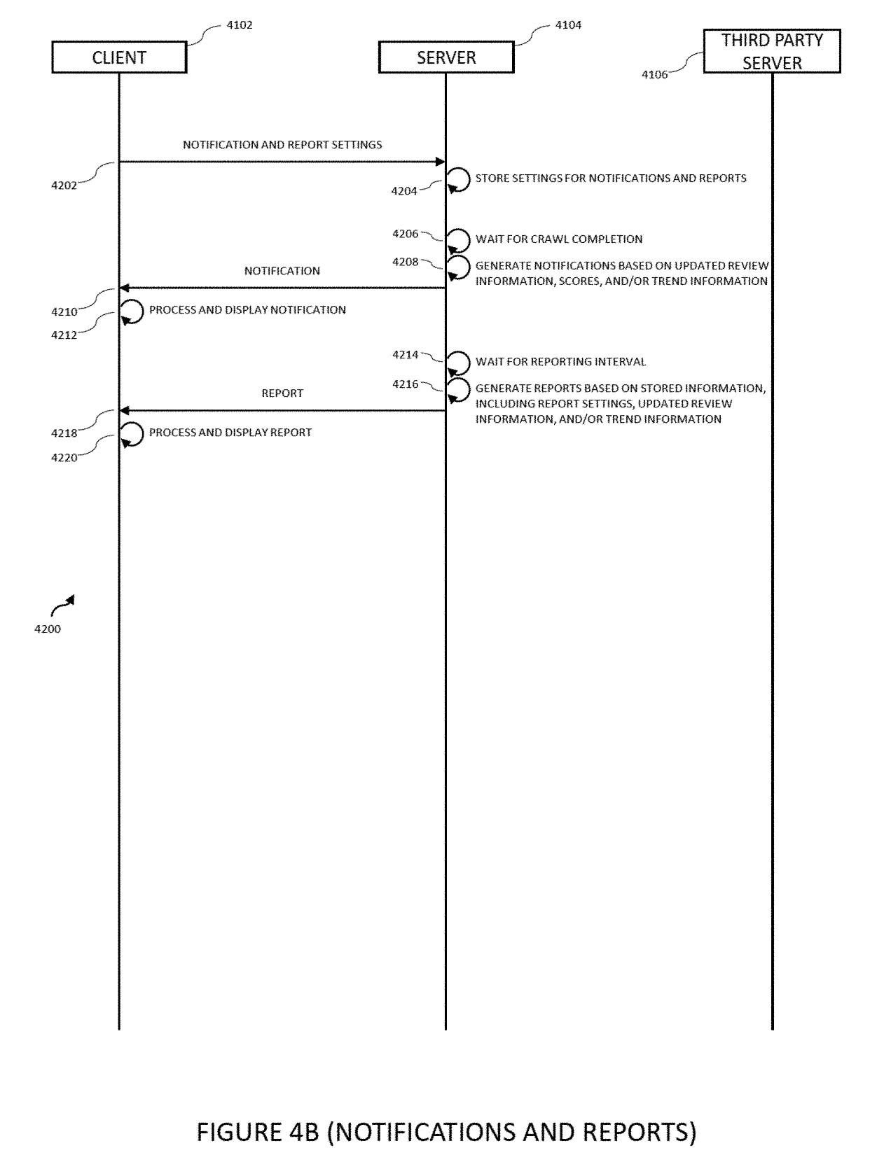

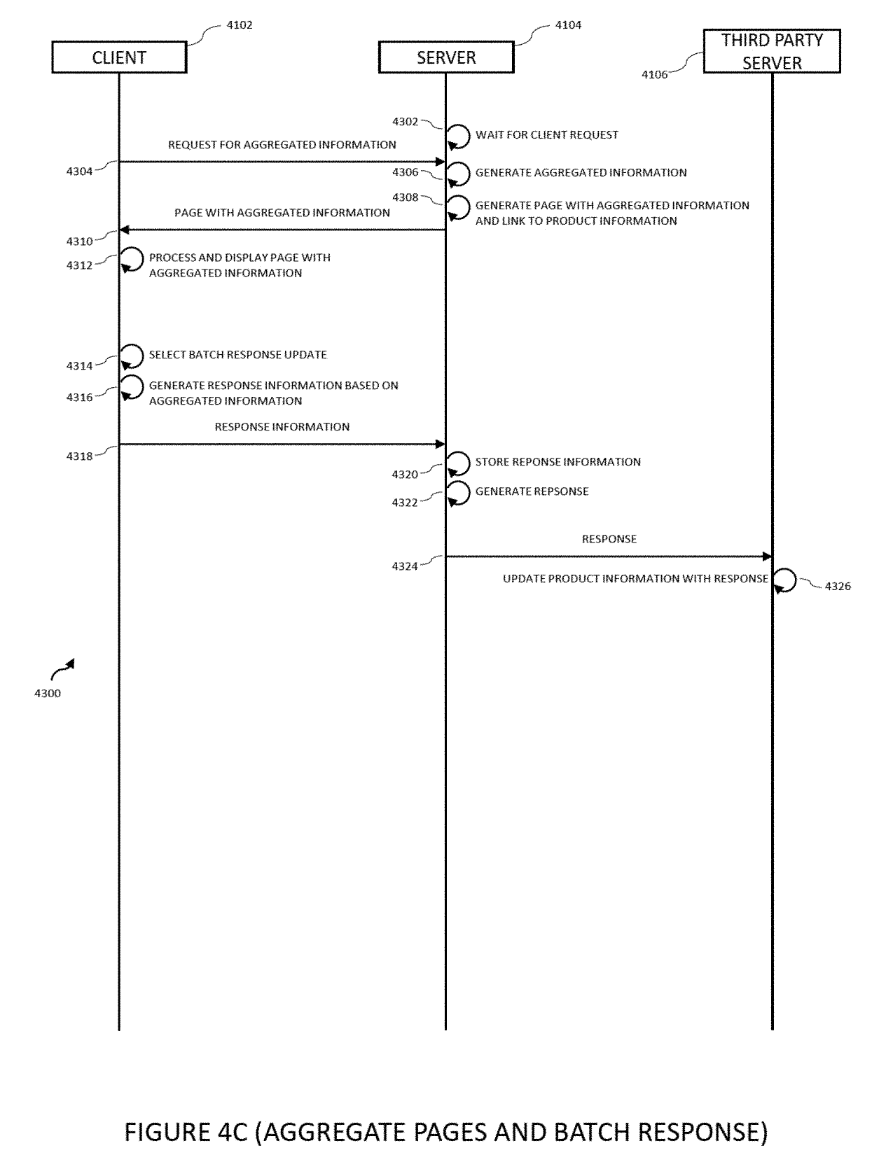

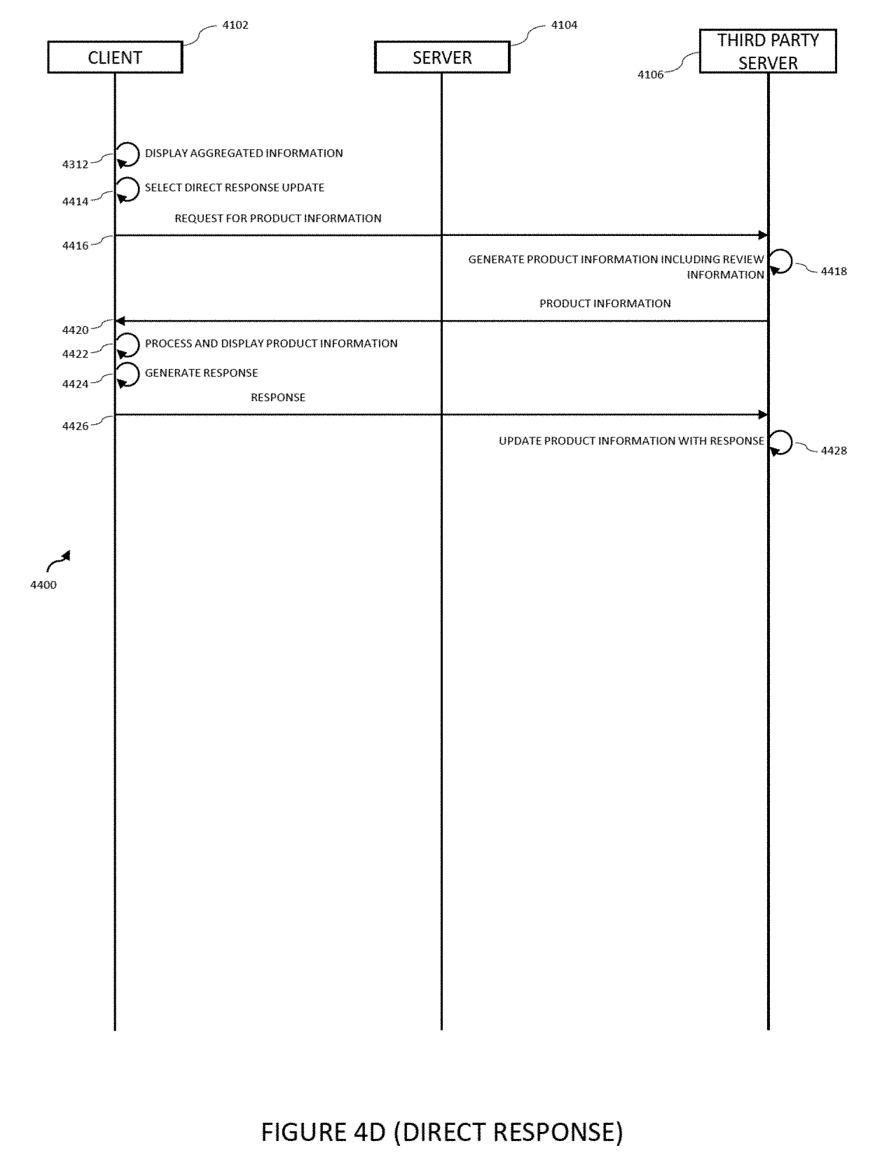

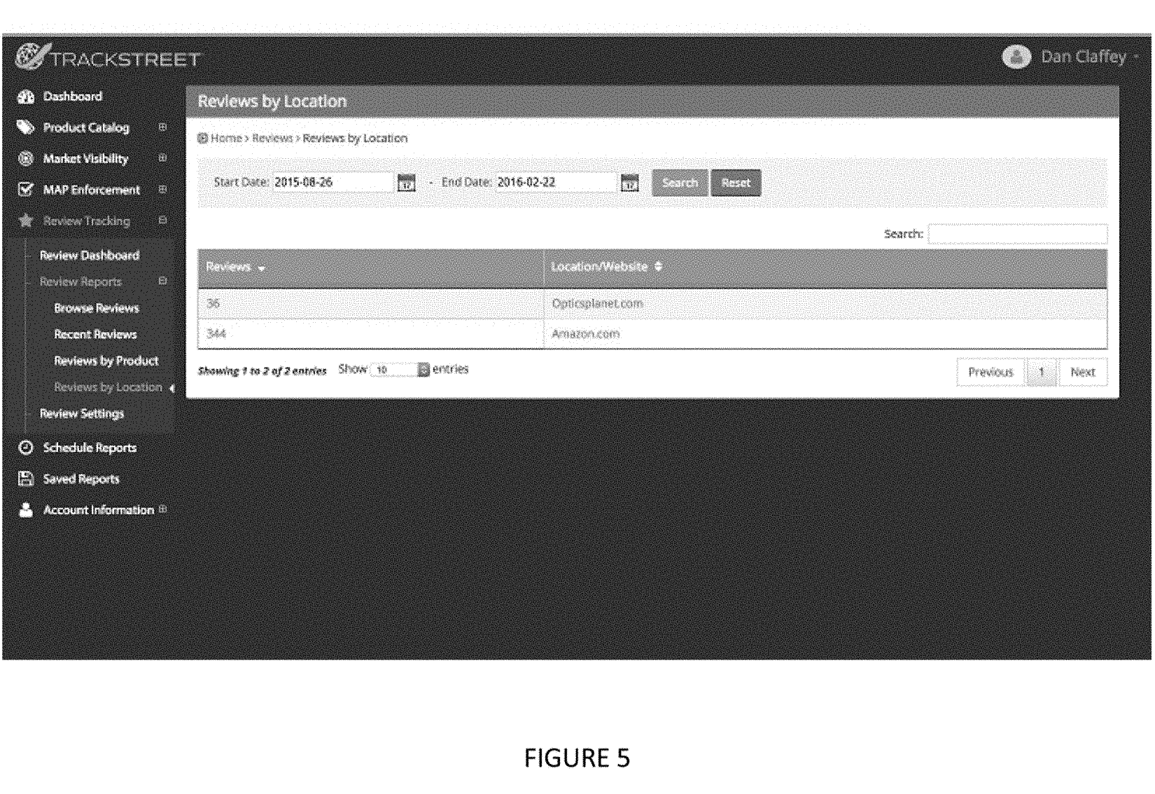

Referring to FIG. 3E, process 3500 implements a machine learning algorithm that can be used in step 325 of FIG. 3A, step 3318 of FIG. 3C, step 3416 of FIG. 3D, and step 4150 of FIG. 4A.

At step 3502, process 3500 starts. Machine learning system 3504 runs process 3500 by accessing reviews at step 3506 that are stored in a database accessible through relational database service 114.

At step 3508, machine learning system 3504 identifies the review text from one review to process.

At step 3510, a word clustering algorithm (further described in FIG. 3F), is used to process the review text.

At step 3512, machine learning system 3504 determines if the review is positive or negative by calculating a value or score with the word clustering algorithm.

At step 3514, the review is updated to be associated with the value or score determined by machine learning system 3504.

At step 3516, the value or score are persisted to the database through relational database service 114.

In an alternative embodiment, a neural network is used that takes the review text as an input to a recurrent convolutional neural network that outputs a predicted rating based on the network state and the review text input. The training data for the neural network are the review text and ratings pairs that are gathered from websites that include both review text descriptions and ratings. After training on this data, the system can then be used to predict a rating for websites that provide review text, but not ratings. For example, the machine learning system can use a Twitter tweet or Facebook post as the input and then provide a predicted rating as an output, which is based on the state of the trained network and the input data.

Referring to FIG. 3F, process 3600 performs a word clustering algorithm and is a further description of step 3510 of FIG. 3E.

At step 3602, process 3600 begins by receiving textual input. The textual input is text that is associated with a product identified by a client. In a preferred embodiment, the textual input is one of the review text from a retail website and text from a post to a social media website.

At step 3604, the words from the text are split into an array and whitespace is removed.

At step 3606, each word is given a weighted value between 0.0 and 1.0, where 0.0 is very negative, 0.5 is neutral, and 1.0 is very positive. The chart below shows an example of the weighted values for certain words.

| Word | Weighted Value |
|---|---|
| Excellent | 0.8 |
| Good | 0.75 |
| Bad | 0.25 |
| Terrible | 0.2 |

At step 3608, the weighted values of the words are averaged to generate a score for the text and stored to the database with relational database service 114. For example, a social media post of “These boots are excellent, too bad they didn't arrive sooner!” would be scored as:

| Text Array | Word Weight |
|---|---|
| These | 0.5 |
| boots | 0.5 |
| are | 0.5 |
| excellent, | 0.8 |
| too | 0.5 |
| bad | 0.25 |
| they | 0.5 |
| didn't | 0.5 |
| arrive | 0.5 |
| sooner! | 0.5 |
| Combined Value | 0.505 |

At step 3610, a word occurrence and overall outlook are calculated for the text and stored to the database with relational database service 114. In a preferred embodiment, the word occurrence identifies the number of positive words above a positive weight threshold and the number of negatively weighted words below a negative weight threshold and the outlook averages the words identified in the word occurrence. From the above example, the word occurrence would be:

| Description | Count | Sum of Weights |
|---|---|---|
| Words weighted above 0.6 | 1 | 0.8 |
| Words weighted below 0.4 | 1 | 0.25 |

and the outlook would be:

| Description | Word Count | Sum of Weights | Average |
|---|---|---|---|
| Outlook | 2 | 1.05 | 0.525 |

The score, word occurrence, and outlook are associated with the review information and product information and stored to the database through relational database service 114.

At step 3612, the client interface, reports, and notifications that are associated with and listening for updates to the product information are updated by generating any necessary updates to client interfaces (e.g., web browsers), new notifications, and new reports when there is a change to the database.

Referring to FIG. 3G, process 3700 for analyzing trends is described, and is a further description of step 327 of FIG. 3A and step 4154 of FIG. 4A. In a preferred embodiment, the trends are analyzed on a per product basis.

At step 3702, process 3700 starts by receiving textual input. In a preferred embodiment, the textual input includes all of the review text that has been stored on the system for a product identified by a client. The review text also includes social media posts.

At step 3704, for each unit of text, i.e., for each review or post, the text is split into an array of strings.

At step 3706, the system compares words to previous occurrence patterns. In a preferred embodiment, each array of strings (words) is compared with the other arrays of strings associated with the same product. An overall word occurrence is generated that identifies how often a word occurs in a review or post. In a preferred embodiment, the overall word occurrence is array 3708 where each tuple contains:
a word,
a count of the total number of occurrences of the word (or similar word form) in all of the textual input,
an average occurrence value that identifies how many times the word appears in a review or post on average, and
the weight of the word.

At step 3710, array 3708 is analyzed based on one or more word weights, occurrences, and previous data runs. In a preferred embodiment, array 3708 is analyzed to generate a weighted average that is the overall outlook. The average occurrence value is multiplied by the weight for each word in array 3708. This product for each word is then summed and then divided by the sum of the average occurrence values to arrive at an overall outlook, as shown in the equation below:

$$overall outlook = \frac{{\sum }_{i = {word}_{1}}^{{word}_{n}} average occurrence {value}_{i} * {weight}_{i}}{{\sum }_{i = {word}_{1}}^{{word}_{n}} average occurrence {value}_{i}} \qquad Eq . 1$$

The overall outlook is calculated for the most recent review data, the historical review data without the most recent review data, and the historical data with the most recent review data. Comparison of these different overall outlooks that use different time frames of data is performed to determine if there is an increase is the overall outlook.

In one embodiment, a positive outlook is generated that is a weighted average of the words with positive weights and a negative outlook is generated that is a weighted average of the words with negative weights. For each of the weighted averages, thresholds may be used so that words with weights that do not meet the threshold will not be used to determine the weighted average.

At step 3712, notifications that associated with the trends and outlooks computed by the system are generated and sent to one or more clients.

At step 3714, the trend data including the overall outlooks generated with process 3700 are stored to the database through relational database service 114.

Referring to FIG. 3H, process 3800 sets up one or more notifications that are sent by step 331 of FIG. 3A and process 3900 of FIG. 31.

Client administration interface 3802 is used to perform step 3804, where the client identifies which notifications should be generated, who should receive the notifications, how the notifications should be transmitted, and when the notifications should be transmitted. Each notification has a specific trigger that causes the notification to be sent. Triggers include identification of one or more negative reviews below a negative review threshold during a crawl, identification of one or more positive reviews above a positive review threshold during a crawl, a trend change from positive to negative or vice versa, a positive trend change that is above certain threshold, and a negative trend change that is below a certain threshold. Recipients of the notifications are identified with contact information that is provided to the system. Each recipient can have multiple contact methods, including by email or text message, and the system stores the preference to use text, email, or both to provide notifications. Notifications may be sent as soon as a crawl is finished, or it can be delayed to any time of the day. For example, a crawl that regularly finishes early in the morning might have its notification settings adjusted so that the notifications are sent later in the morning or midday.

At step 3806, the information sent from the client to the system is stored to the database through relational database service 114.

Referring to FIG. 31, process 3900 pushes notifications to the users and clients of the system. Process 3900 is a further description of step 331 of FIG. 3A.

At step 3902, notification settings are accessed from the database through relational database service 114.

At step 3904, a content analysis process starts and analyzes review information. This analysis serves as the basis for the notifications.

At step 3906, the system determines which notifications have been triggered and need to be sent. The determination is based on changes to review information and trend information collected and generated by the system.

At step 3908, the system identifies which notifications need to be sent to a client.

At step 3910, for a given notification that needs to be sent, the system determines the delivery mechanism of the notification, i.e., whether the notification needs to be sent by text, email, or both. The delivery mechanism is specified in the user settings provided by the client.

At step 3912, after determining that a notification needs to be sent by a text message, the system generates a message in accordance with the API of text notification service 3914 and sends the message with the notification to text notification service 3914. Text notification service 3914 then sends a text message to the client that includes the notification. In one embodiment, the text notification service is provided by Twilio, Inc.

At step 3916, the system has determined that a notification needs to be sent by email. A message is generated by the system that can be translated into an email and which includes the notification. The message with the notification is sent to the client using email notification service 3918. In one embodiment, the email notification service is Amazon simple notification service (SNS), provided by Amazon Web Services, Inc.

Referring to FIG. 4A, flow diagram 4100 describes the process for setting up the crawling service with notifications and for crawling the Internet, which are also described in FIGS. 3A, 3D, and 3H. In a preferred embodiment, client 4102 is a personal computing device, such as a desktop computer, laptop, mobile phone, smartphone, and tablet computer. Server 4104 is connected to a database to persist data generated and received by server 4104. Third party server 4106 hosts a website that provides review information for products, such as retail websites or social media sites. One or more of client 4102, server 4104, and third party server 4106 communicate with each other through the Internet.

At step 4122, product information is sent from client 4102 to server 4104. The product information includes one or more text, images, and URLs that are used to identify a product and identify the locations of review information on the Internet for that product.

At step 4124, server 4104 stores the product information provided by client 4102. In a preferred embodiment, the data is stored using a database engine, such as Amazon Aurora, PostgreSQL, MySQL, MariaDB, Oracle, and Microsoft SQL Server, which is maintained and accessed through a relational database service, such as Amazon RDS.

At step 4126, server 4104 generates a search list of URLs that are related to the product information. The search list of URLs includes the URLs that will be searched in order to generate or fill in any missing product information that was not provided by client 4102, such as a UPC code or image.

At step 4128, server 4104 searches for additional product information. In a preferred embodiment, server 4104 selects a URL from the search list and sends an HTTP request to third party server 4106 for the content associated with the URL from the search list.

At step 4130, third party server 4106 generates the additional product information. In response to the request from server 4104, third party server 4106 generates or provides the HTML content associated with the URL from the search list. In one embodiment, the additional product information is retrieved from a database and inserted into an HTML file or web page.

At step 4132, the additional product information is sent from third party server 4106 to server 4104. In one embodiment, the additional product information is provided in a web page served by third party server 4106 to server 4104 in response to the request from server 4104.

At step 4134, server 4104 generates a crawl list or master list of URLs that will be searched during the next crawl. In a preferred embodiment, the crawl list includes one or more URLs provided by client 4102 as well as additional URLs that were identified by server 4104 when it searched for additional product information.

At step 4136, server 4104 generates one or more filters for each URL in the crawl list. The filters allow for extraction of relevant data, e.g., author name, review text, and rating, from the content that is retrieved by accessing the URLs of the crawl list.

At step 4138, server 4104 waits for a periodic crawl interval before starting the crawl. In a preferred embodiment, the periodic crawl interval is one day and a specific start time is identified, e.g., 2:00 AM local time.

At step 4140, server 4104 begins the crawl and requests product information from third party server 4106. The request is based on a URL from the crawl list.

At step 4142, third party server 4106 generates product information. The product information generated by third party server 4106 is in response to the request received from server 4104.

At step 4144, server 4104 receives the product information from third party server 4106. In a preferred embodiment, the product information is sent using HTTP.

At step 4146, server 4106 filters the product information for review information. In a preferred embodiment, the filters include XPath expressions that, when evaluated against the content received from third party server 4106, extracts the review information.

At step 4148, server 4104 checks for updated review information. In a preferred embodiment, server 4104 compares the review information that was received in the crawl with review information that that was received from the same URL on a prior crawl of the Internet. The review information may contain more than one collection of information, such as review text and a rating. Server 4104 checks each type of information to see if it has been updated. Review information that does not match the prior review information is identified as updated review information and will be further processed.

At step 4150, server 4104 generates values for the updated review information. The values includes one or more scores, outlooks, and weighted averages that are determined from the updated review information.

At step 4152, server 4104 stores the values and updated review information to the database.

At step 4154, server 4104 generates trend information. The trend information identifies changes in the scores or weighted averages of the review information over one or more time intervals. In one embodiment, the scores and outlooks are consolidated into daily, weekly, monthly, and yearly trend information.

Referring to FIG. 4B, flow diagram 4200 illustrates the processes and methods used to generate notifications and reports, which is also described in FIGS. 3A (steps 329 and 331 ) and 3I.

At step 4202, client 4102 sends notification and report settings to server 4104. The notification and report settings identify which notifications and reports will be generated, which users they will be pushed to, how they will be published, and when they will be sent.

At step 4204, server 4104 stores the settings for notifications and reports that were received from client 4102.

At step 4206, server 4104 waits for crawl completion. The crawl is completed after all the URLs in the crawl list have been processed and, in a preferred embodiment, occurs once per day.

At step 4208, server 4104 generates notifications based on updated review information, scores, and/or trend information.

At step 4210, a notification is sent from server 4104 and is received by client 4102.

At step 4212, the notification received from server 4104 is processed and displayed. In a preferred embodiment, client 4102 is a smartphone and the notification from server 4104 is displayed in a notification bar and, when selected, displays the additional details of the notification. For example, when the notification is for a new review that is not good, an icon associated with a new review is displayed in the notification bar. After selecting the notification, the review text from the new review is displayed with options for how respond to the new review.

At step 4214, server 4104 waits for a reporting interval to pass. Reports are generally sent out less frequently than notifications. In a preferred embodiment, the reporting interval for each type of repot generated by the system is set to one of weekly, monthly, quarterly, semi-annually, and annually.

At step 4216, server 4104, generates reports based on stored information, including report settings, updated review information, and/or trend information. Different reports generated by the system can have different reporting intervals, e.g., reports that include weekly trend information are sent weekly and reports that include monthly trend information are sent monthly.

At step 4218, server 4104 sends a report to client 4102. In one embodiment, the report is generated as a portable document format (PDF) file that is emailed to client 4102.

At step 4220, client 4102 processes and displays the report received from server 4104.

Referring to FIG. 4C, flow diagram 4300 illustrates processes for generating aggregate pages and providing batch responses. The generation of aggregate pages is a further description of step 3420 of FIG. 3D.

At step 4302, server 4104 waits for a request from client 4102.

At step 4304, server 4104 receives a request for aggregated information from client 4102. In a preferred embodiment, the request for aggregated information is a request for a web page that is hosted by server 4104.

At step 4306, server 4104 generates the aggregated information. In a preferred embodiment, server 4104 retrieves review information and trend information and generates additional analysis information, such as a count of the number of reviews for each product.

At step 4308, server 4104 generates a page with the aggregated information and links/URLs for the content hosted by third party server 4106 that was used to generate the aggregated information. In a preferred embodiment, the page is an HTML document of the web page.

At step 4310, server 4104 sends the web page and client 4102 receives the web page with the aggregated information and links.

At step 4312, client 4102 processes and displays the web page with at least a portion of the aggregated information.

At step 4314, client 4102 selects to use a batch response update. The batch response update is used to provide responses to one or more reviews using server 4104. By providing the responses to server 4104 and using server 4104 to post the responses, server 4104 can track and verify whether the responses were properly stored by third party server 4106 during the next crawl.

At step 4316, response information is generated by client 4102. In a preferred embodiment, the response information includes a response message that is generated for each of the review that is new and was not positive.

At step 4318, the response information is transmitted from client 4102 and is received by server 4104.

At step 4320, server 4104 stores the response information received from client 4102.

At step 4322, server 4104 generates responses based on the response information. The response information is reformatted to be appropriate for the format required by third party server 4106.

At step 4324, server 4104 sends a response with response information to third party server 4106.

At step 4326, third party server 4106 updates the product and/or review information to include the response information.

Referring to FIG. 4D, flow diagram 4400 describes the processes used to provide direct responses to review information. The direct response updates of FIG. 4D are an alternative that can be used in addition to the batch response updates of FIG. 4C.

At step 4312, client 4102 displays aggregated information. The aggregated information includes review information for multiple products and includes links to content and reviews hosted by third party server 4106 that were used to generate the aggregated content.

At step 4414, an update by direct response is selected with client 4102.

At step 4416, a request for product information is sent from client 4102 and received by third party server 4106. In a preferred embodiment, the request is sent in response to the selection of a link that was displayed within the aggregated content and that is to a review from which the aggregated content was generated.

At step 4418, third party server 4106 generates product information that includes the review information. In a preferred embodiment, third party server 4106 retrieves the review information from a database and wraps it into a web page to be delivered to client 4102.

At step 4420, the product information is sent from third party server 4106 and is received by client 4102.

At step 4422, the product information is processed and displayed by client 4102. In a preferred embodiment, the product information is displayed in a web browser and the focus of the web browser is brought to the review information.

At step 4424, client 4102 is used to generate a response to the review that contains the review information.

At step 4426, the response is sent from client 4102 to third party server 4106.

At step 4428, third party server 4106 updates the product information to include the response generated with client 4102. During the next crawl, server 4104 will identify the response if it was properly stored by third party server 4106.

Referring to FIG. 5, a reviews by location data entry form and a report page is shown. In reviews by location data entry form and report page, reviews are shown according to a numerical count and a location. A start date and an end date can be specified in the instructions set by data entry boxes on the form. The form allows the user to also choose to add to the construction set a product catalog designation, a market visibility counter organization, a map enforcement, and various review tracking parameters. The form also allows the user to change and schedule report times, save reports, and view account information. FIG. 4 shows a review by location data form and report.

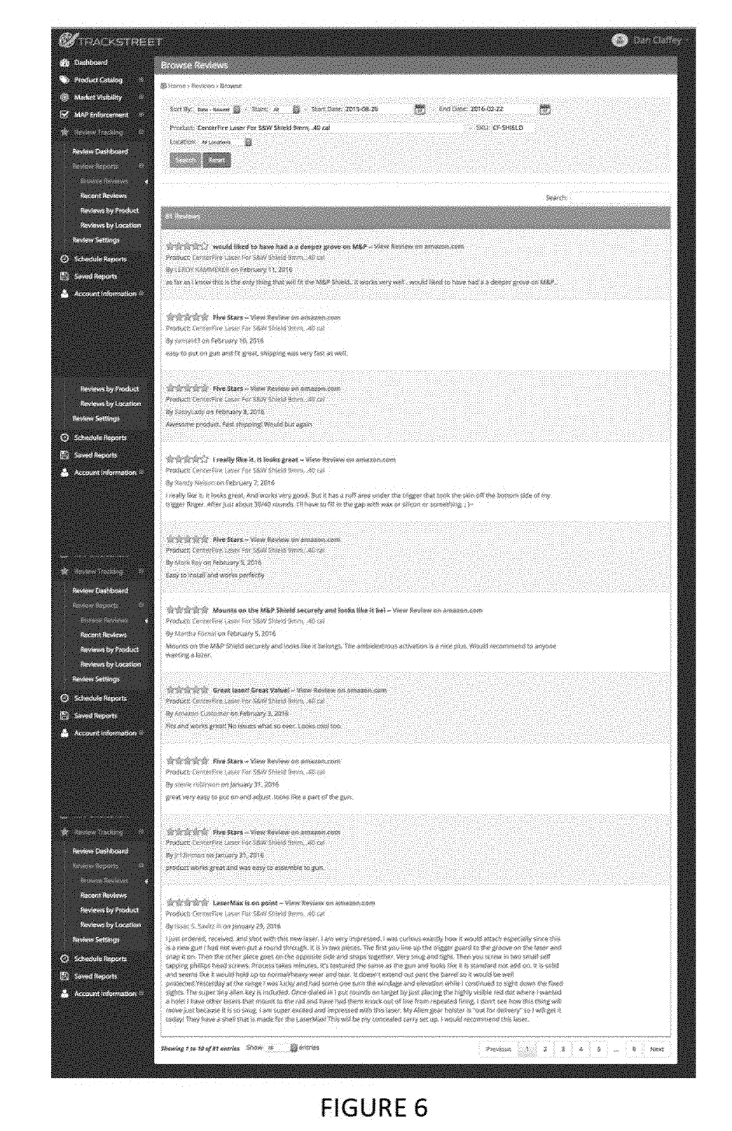

Referring to FIG. 6, a browse reviews data entry form and report is shown. The report shows the actual text of the reviews scraped from the internet by the crawler along with a star rating and location. The form allows the user to include in the instruction set a sort by date filter, a number of stars filter, a start date filter, and an end date filter. The form also allows the user to pick a product, a location, and a SKU number. Once an instruction set is designated a search function is activated in the form which submits a query to the database.

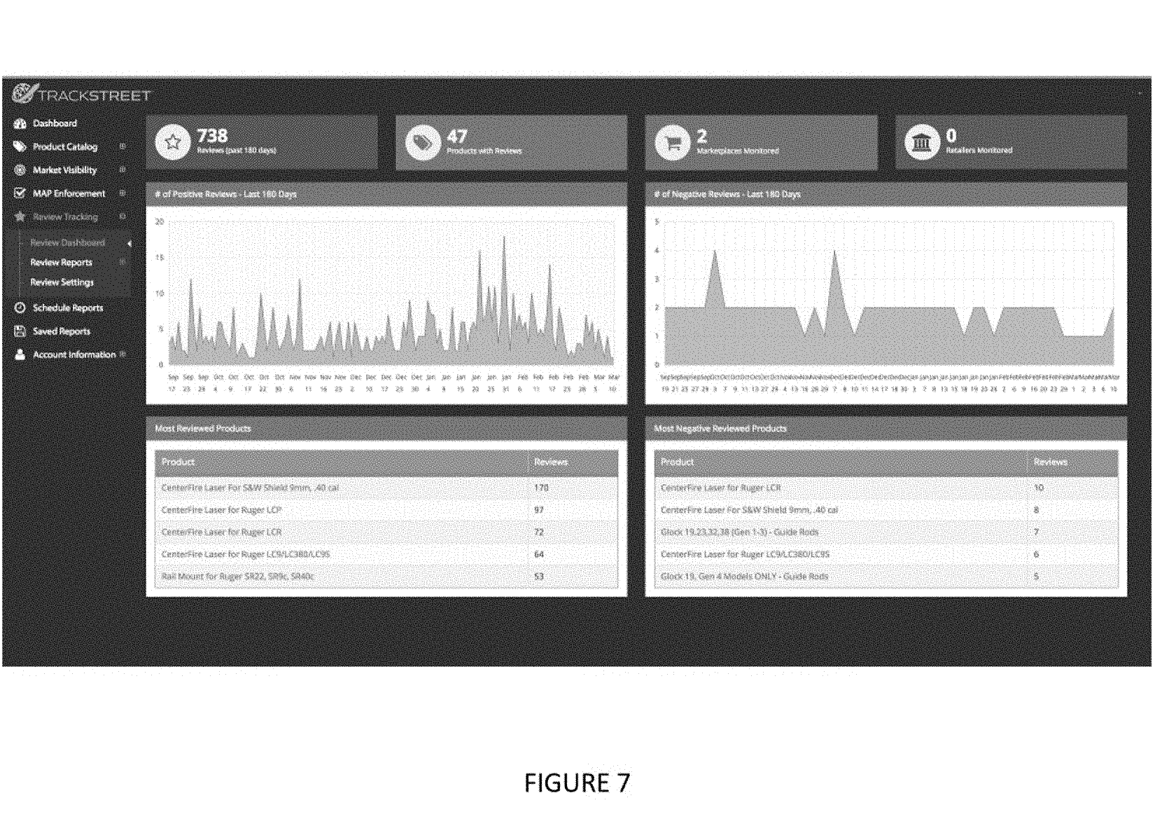

Referring to FIG. 7, an account metrics form and report page is shown. The account metrics report includes a number of a number of positive reviews and a number of negative reviews. The metrics are derived by the analysis routine of the system. The metrics are abstractions derived by the analysis routine and can change as often as the crawl timer interrupt is activated. Graphics are supplied in the report which include data analyses of positive reviews and negative reviews.

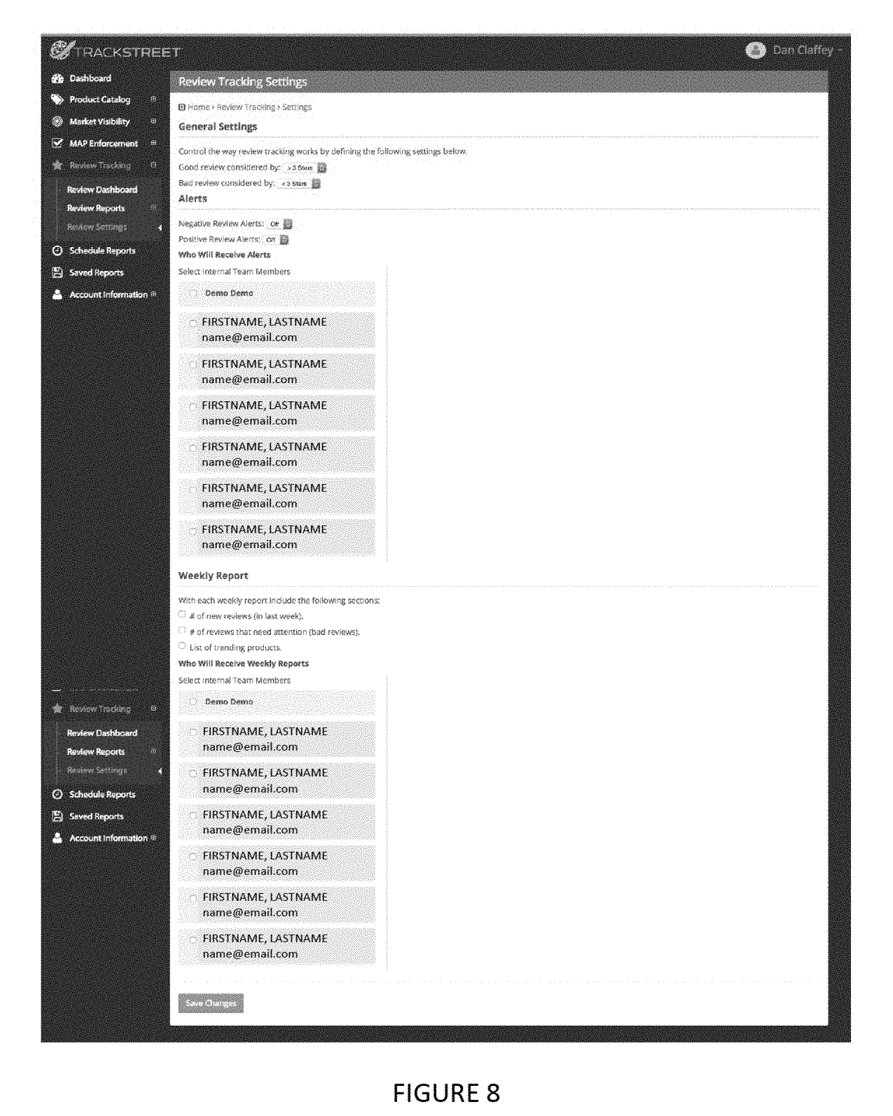

Referring to FIG. 8, a review tracking settings form is shown. The review tracking settings form allows the user to update settings for notifications and reports and to create an instruction set to be submitted to the content organizer module for creating the notifications and reports. The form allows choices of good or bad reviews, negative or positive review alerts, a listing of alert recipients and timing of report distributions.

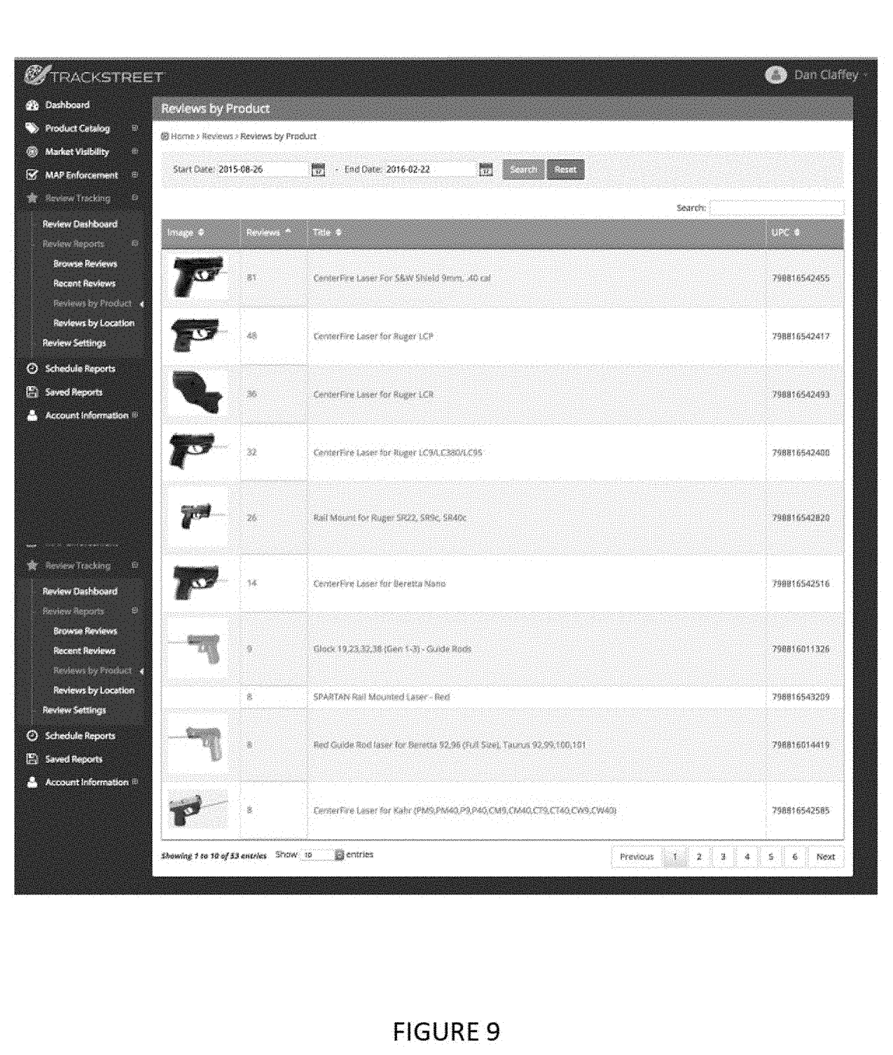

Referring to FIG. 9, a review by product form and report is shown. The reviews by product form allows a start date filter and an end date filter to be submitted to the instruction set. The reviews by product report shows an image of the product, a total number of reviews for each product, and title for each product. The form also includes a UPC code for each product.

It will be appreciated by those skilled in the art that the described embodiments disclose significantly more than an abstract idea including technical advancements in the field of data processing and a transformation of data which is directly related to real world objects and situations in that the disclosed embodiments enable a computer to operate more efficiently.

It will be appreciated by those skilled in the art that modifications can be made to the embodiments disclosed and remain within the inventive concept, such as by omitting various described features, rearranging features, and using features from one embodiment in another embodiment. Therefore, this invention is not limited to the specific embodiments disclosed, but is intended to cover changes within the scope and spirit of the claims.

1. A computer implemented method executed by a server to process product information, the method comprising:
receiving second product information from a third party server;
filtering the second product information for review information;
generating a score for the review information; and,
generating a notification based on the score.

2. The computer implemented method of claim 1, further comprising:
receiving first product information from a client; and,
generating a search list that includes one or more uniform resource locators (URLs).

3. The computer implemented method of claim 2, further comprising:
generating one or more filters for each URL in the search list.

4. The computer implemented method of claim 3, further comprising:
generating a request for the second product information based on the first product information.

5. The computer implemented method of claim 4, further comprising:
generating an XPath expression to use as a filter for a URL.

6. The computer implemented method of claim 5, further comprising: executing the XPath expression to extract the review information from the second product information.

7. The computer implemented method of claim 6, further comprising:
generating the score by assigning a weight to one or more words in review text of the review information and averaging the assigned weights.

8. The computer implemented method of claim 7, further comprising:
generating trend information from the review information and prior stored review information.

9. The computer implemented method of claim 8, further comprising:
generating a report based on stored information that includes settings received from a client, the review information, and the trend information.

10. The computer implemented method of claim 9, further comprising:
generating aggregated data with the review information;
generating a web page with the aggregated data; and,
sending the web page to the client.

11. A system to process product information, the system comprising:
a server that includes one or more memories and processors with instructions that cause the server to perform the steps of:
receiving second product information from a third party server;
filtering the second product information for review information;
generating a score for the review information; and,
generating a notification based on the score.

12. The system of claim 11, wherein the instructions further cause the server to perform the steps of:
receiving first product information from a client; and,
generating a search list that includes one or more uniform resource locators (URLs).

13. The system of claim 12, wherein the instructions further cause the server to perform the step of:
generating one or more filters for each URL in the search list.

14. The system of claim 13, wherein the instructions further cause the server to perform the step of:
generating a request for the second product information based on the first product information.

15. The system of claim 14, wherein the instructions further cause the server to perform the step of:
generating an XPath expression to use as a filter for a URL.

16. The system of claim 15, wherein the instructions further cause the server to perform the step of:
executing the XPath expression to extract the review information from the second product information.

17. The system of claim 16, wherein the instructions further cause the server to perform the step of:
generating the score by assigning a weight to one or more words in review text of the review information and averaging the assigned weights.

18. The system of claim 17, wherein the instructions further cause the server to perform the step of:
generating trend information from the review information and prior stored review information.

19. The system of claim 18, wherein the instructions further cause the server to perform the step of:
generating a report based on stored information that includes settings received from a client, the review information, and the trend information.

20. The system of claim 9, wherein the instructions further cause the server to perform the steps of:
generating aggregated data with the review information;
generating a web page with the aggregated data; and,
sending the web page to the client.
